(19) United States
(12) Patent Application Publication
(10) Pub. No.: US 2022/0144176 A1
(43) Pub. Date: May 12, 2022

(54) METHOD FOR PRODUCING A LUGGAGE COMPARTMENT COVERING AND LUGGAGE COMPARTMENT COVERING FOR VEHICLES

(71) Applicant: Adient Engineering and IP GmbH, Burscheid (DE)

(72) Inventors: Dita CHUMOAVÁ, Strakonice (CZ); Marcela LYEROVÁ, Jaromer (CZ); Miroslav RÍHA, Strakonice (CZ)

(21) Appl. No.: 17/436,676

(22) PCT Filed: Mar. 6, 2020
(86) PCT No.: PCT/EP2020/055972

§ 371 Date: Sep. 7, 2021

(30) Foreign Application Priority Data
Mar. 7, 2019 (DE) 10 2019 105 806.6

(51) Int. Cl. B60R 5/04; D03D 15/47; D02G 3/40

(52) U.S. Cl. CPC B60R 5/047; D03D 15/47; D10B 2505/12; D10B 2401/041; D02G 3/402

(57) ABSTRACT

A method for producing a luggage compartment covering for vehicles may provide for a textile fabric having at least one two-component yarn having a first component and a second component. The method may also provide for thermally treating the fabric such that the first component of the two-component yarn at least partially melts while the second component remains in a solid state of aggregation. A luggage compartment covering for vehicles made by the method is also provided.

The invention relates to a method for producing a luggage compartment covering and to a luggage compartment covering for vehicles, in particular motor vehicles.

### PRIOR ART

A method is known from DE 195 17 350 C1, in which method for producing a multi-component thread two polymer melts which differ in terms of their composition are brought together for melt-spinning the filaments. So-called bicomponent filaments of this type are fundamentally based on the melt components that are unified in the filament having different physical properties so as to obtain particular effects, for example inherent crimp.

A securing device is known from DE 102 56 347 A1. Provided in this securing device is a flexible planar structure which in a vertical position can be utilized as a separation device between the passenger area and the luggage compartment, on the one hand, and in the horizontal position of said separation device can be utilized as a luggage compartment covering, on the other hand. In order for this securing device in the horizontal position thereof to be able to completely cover the luggage compartment of the vehicle, triangular additional portions are provided separately from the flexible planar structure in a rear portion, said triangular additional portions when not in use being able to be folded away into a vehicle cladding and, when extracting the planar structure from a winding shaft, automatically pivoting into the luggage compartment.

A roller shutter in which a roller shutter web configured in multiple layers or multiple plies, respectively, has one ply formed by a non-woven structure and another ply formed by a textile material is known from DE 10 2005 010 788 A1. The non-woven structure here serves as a carrier material for the textile material.

### OBJECT

The invention is based on the object of improving a textile planar structure of the type mentioned at the outset, in particular of providing a more lightweight or more stable planar structure and a corresponding luggage compartment covering.

### ACHIEVEMENT

This object is achieved according to the invention by a method for producing a luggage compartment covering for vehicles, said method comprising the following method steps:

providing a textile planar structure comprising at least one bicomponent yarn having a first component and a second component,

thermally treating the planar structure such that the first component of the bicomponent yarn melts at least in part, while the second component remains in a solid aggregate state.

A luggage compartment covering which has a high strength and at the same time a light weight is achieved by the method proposed according to the invention. Moreover, the luggage compartment coverings produced are highly dimensionally stable and do not tend to snarl or get entangled when being rolled up in a retraction device, in particular for roll-up coverings.

The textile planar structure can have at least one further yarn.

The bicomponent yarn of the planar structure, by fusing the first component, can establish a materially integral connection to a further bicomponent yarn or a further yarn.

At least the first component of the bicomponent yarn can be a low melting point polyester. A melting temperature of the first component of the bicomponent yarn can be lower than a melting temperature of the second component of the at least one bicomponent yarn. A melting temperature of the first component of the bicomponent yarn can be in a range from 110° C. to 160° C., in particular in a range from 125° C. to 140° C. A melting temperature of the second component of the bicomponent yarn can be in a range from 240° C. to 280° C., in particular in a range from 250° C. to 265° C.

A second component of the bicomponent yarn can be a plastics material fiber. The second component of the bicomponent yarn can be a polyester fiber. The second component of the bicomponent yarn can be a natural fiber.

The bicomponent yarn can be formed from a fiber, wherein the fiber is a bicomponent fiber. The bicomponent fiber can have a core made from a second polyester material and a sheathing made from a low melting point first polyester material. The low melting point first polyester material can have a lower melting temperature in comparison to the second polyester material. The further yarn can be made from the second polyester material. The further yarn can be a further bicomponent yarn.

A materially integral connection between the bicomponent yarn, in particular the sheathing of the bicomponent yarn, and a further yarn can be generated by the thermal treatment of the planar structure at the respective contact points of the bicomponent yarn with a further yarn.

The bicomponent yarn can be formed from a plurality of fibers, wherein a first proportion of the fibers is formed from the first component and a second proportion of the fibers is formed from the second component.

The textile planar structure can be a non-woven fabric. The textile planar structure can be a knitted fabric. The textile planar structure can be a woven fabric. The woven fabric can have at least one bicomponent yarn processed in the weft direction. The textile planar structure can be a woven fabric having at least one bicomponent yarn processed in the weft direction. The woven fabric can have a further yarn processed in the warp direction. The textile planar structure can be a woven fabric having a bicomponent yarn processed in the warp direction.

The underlying object is likewise achieved according to the invention by a luggage compartment covering for vehicles, in particular motor vehicles, produced by a method according to the above description.

The luggage compartment covering can have a first fastening means by which the luggage compartment covering is able to be assembled on a luggage compartment wall, for example. The luggage compartment covering can have a first fastening means for assembling the luggage compartment covering on a roll-up device. The luggage compartment covering can have a second fastening means by which the luggage compartment covering is able to be assembled on a luggage compartment wall, for example, in particular in the region of a luggage compartment hatch of a vehicle.

### FIGURES AND EMBODIMENTS OF THE INVENTION

Before describing design embodiments of the invention in more detail by figures, it is to be noted first that the invention is not limited to the described components or to the described method steps. Furthermore, the terminology used does not represent any limitation but has a merely exemplary characteristic. Insofar as the singular is used hereunder in the description and the claims, the plural is in each case included therein unless this is explicitly precluded by the context.

The invention hereunder is explained in more detail by an advantageous exemplary embodiment illustrated in the figures. The invention is however not limited to this exemplary embodiment. In the figures:

FIG. 1: shows a perspective view of a luggage compartment covering according to the invention;

FIG. 2: shows a plan view of the luggage compartment covering of FIG. 1; and

FIG. 3: shows a sectional illustration of the luggage compartment covering along the line III-III in FIG. 2.

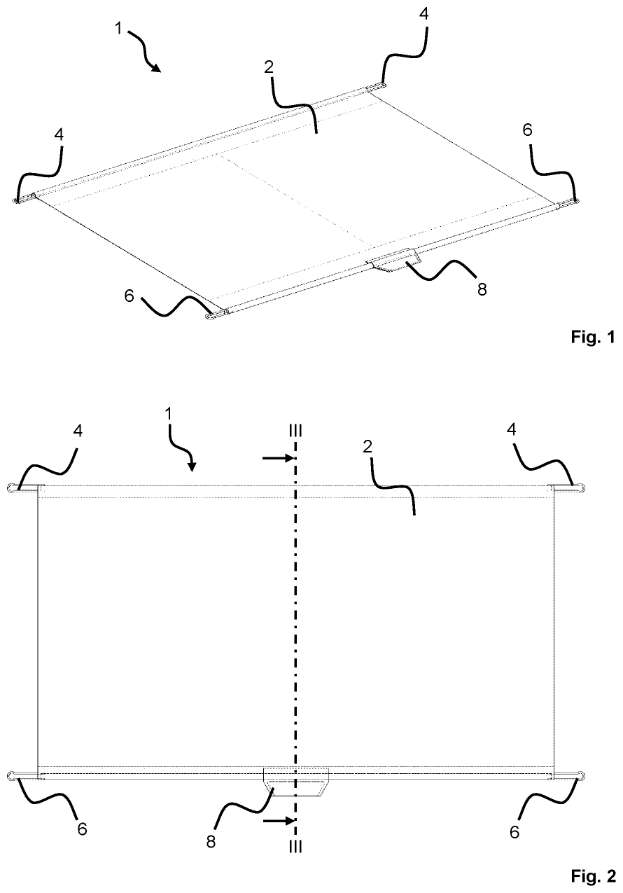

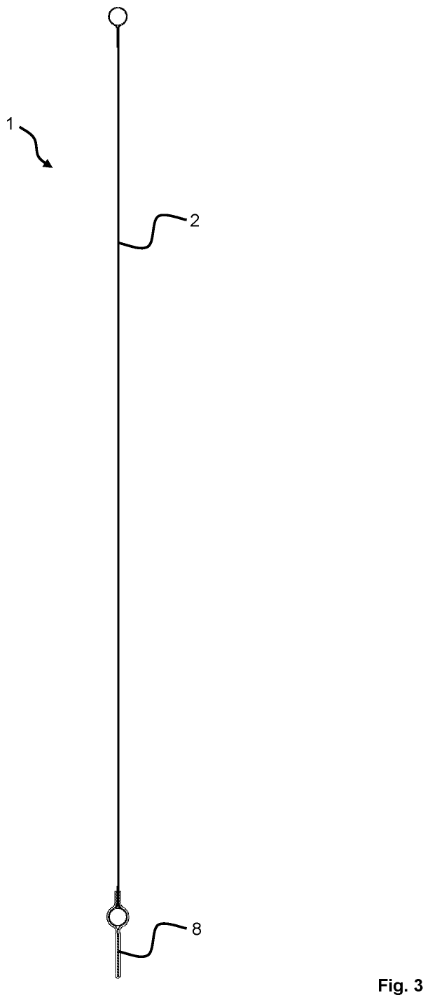

A luggage compartment covering 1 according to the invention is shown in FIG. 1. FIG. 2 shows the luggage compartment covering 1 of FIG. 1 in a plan view. FIG. 3 shows a sectional illustration of the luggage compartment covering 1 along the line III-III in FIG. 2.

The figures are conjointly described hereunder.

The luggage compartment covering 1 has a textile planar structure 2. The luggage compartment covering 1 has first fastening means 4 by which the luggage compartment covering 1 is able to be fixed to a luggage compartment wall, for example. The first fastening means 4 can furthermore serve for assembling the luggage compartment covering 1 on a roll-up device, not illustrated.

The luggage compartment covering 1 has second fastening means 6 by which the luggage compartment covering 1 is able to be fixed to a luggage compartment wall, for example, in particular in the region of a luggage compartment hatch of a vehicle. In order to be manually hooked into or unhooked from a vehicle-proximal mounting for the luggage compartment covering 1, the luggage compartment covering 1 has a handle 8. The handle 8 is preferably is preferably disposed so as to be centric on an edge of the luggage compartment covering 1.

The luggage compartment covering 1 is preferably produced by a method for producing a luggage compartment covering 1 for vehicles, said method comprising the following method steps:

providing a textile planar structure 2 comprising at least one bicomponent yarn having a first component and a second component,

thermally treating the planar structure 2 such that the first component of the bicomponent yarn melts at least in part, while the second component remains in a solid aggregate state.

The textile planar structure 2 is preferably a woven fabric having a bicomponent yarn processed in the weft direction and a further yarn processed in the warp direction. The bicomponent yarn is preferably a yarn formed from a bicomponent fiber. The bicomponent yarn can however also be formed using a plurality of fibers.

According to a preferred embodiment, the bicomponent fiber has a core made from a second polyester material and a sheathing made from a low melting point first polyester material. The low melting point first polyester material here has in particular a lower melting temperature in comparison to the second polyester material. The further yarn is preferably made from the second polyester material. The further yarn can likewise be formed by another plastics material or a natural fiber.

A materially integral connection between the bicomponent yarn, in particular the sheathing of the bicomponent yarn, and the further yarn is generated by the thermal treatment of the planar structure 2 by fusing the first component of the bicomponent yarn at the respective contact points of the bicomponent yarn with the further yarn. In other words, the sheathing of the bicomponent yarn can at least partially be fused with the further yarn and thus establish a connection between the core of the bicomponent yarn and the further yarn.

The features disclosed in the above description, the claims and the drawings may be relevant individually as well as in combination for implementing the various configurations of the invention.

Although the invention has been described in detail in the drawings and the account given above, the accounts should be understood as being illustrative and exemplary and non-restrictive. In particular, the selection of the proportions illustrated for the individual elements in the drawings should not be interpreted as being necessary or limiting. Furthermore, the invention is, in particular, not limited to the exemplary embodiments explained. Further variants of the invention and the implementation thereof can be gathered by a person skilled in the art from the above disclosure, the figures and the patent claims.

Terms such as “comprise”, “have”, “contain” and the like used in the patent claims do not rule out other elements or steps. The use of the indefinite article does not rule out a plurality. An individual device can perform the functions of a plurality of devices or units mentioned in the patent claims.

### LIST OF REFERENCE SIGNS

1 Luggage compartment covering

2 Planar structure

4 First fastening means

6 Second fastening means

8 Handle

What is claimed is:

1-15. (canceled)

16. A method for producing a luggage compartment covering for vehicles, said method comprising the following method steps:
providing a textile structure comprising at least one bicomponent yarn having a first component and a second component, and
thermally treating the textile structure such that the first component of the bicomponent yarn melts at least in part, while the second component remains in a solid state of aggregation.

17. The method as claimed in claim 16, wherein the textile structure has at least one further yarn.

18. The method as claimed in claim 16, wherein the at least one bicomponent yarn of the textile structure, by fusing the first component, establishes a materially integral connection to a further bicomponent yarn or a further yarn.

19. The method as claimed in claim 16, wherein at least the first component of the bicomponent yarn is a low melting point polyester.

20. The method as claimed in claim 16, wherein a melting temperature of the first component is lower than a melting temperature of the second component of the at least one bicomponent yarn.

21. The method as claimed in claim 16, wherein the second component of the bicomponent yarn is a plastic fiber.

22. The method as claimed in claim 16, wherein the second component of the bicomponent yarn is a polyester fiber.

23. The method as claimed in claim 16, wherein the second component of the bicomponent yarn is a natural fiber.

24. The method as claimed in claim 16, wherein the bicomponent yarn is formed from a bicomponent fiber.

25. The method as claimed in claim 16, wherein the textile structure is a woven fabric having at least one bicomponent yarn processed in the weft direction.

26. The method as claimed in claim 16, wherein the textile structure is a woven fabric having a bicomponent yarn processed in the warp direction.

27. A luggage compartment covering for vehicles, comprising:
a textile structure including at least one bicomponent yarn having a first component and a second component, and
wherein the textile structure is made by a process comprising thermally treating the first component of the bicomponent yarn such that the first component melts at least in part, while maintaining the second component in a solid state of aggregation.

28. The luggage compartment covering as claimed in claim 27, further comprising a fastening device configured for attaching the luggage compartment covering to the vehicle.

29. The luggage compartment covering as claimed in claim 27, further comprising: a roll-up device configured for receipt of the luggage compartment covering; and a first fastening device configured for use in rolling up the luggage compartment covering on the roll-up device.

30. The luggage compartment covering as claimed in claim 28, wherein the luggage compartment covering has a second fastening device configured to attach the luggage compartment covering to the vehicle.
